(19) United States
(12) Patent Application Publication
(10) Pub. No.: US 2020/0292888 A1
(43) Pub. Date: Sep. 17, 2020

(54) LIQUID CRYSTAL CELL AND LIQUID CRYSTAL DISPLAY

(71) Applicant: SHARP KABUSHIKI KAISHA, Sakai City, Osaka (JP)

(72) Inventors: MASANOBU MIZUSAKI, Sakai City (JP); HIROSHI TSUCHIYA, Sakai City (JP)

(21) Appl. No.: 16/087,597

(22) PCT Filed: Mar. 17, 2017
(86) PCT No.: PCT/JP2017/010906

§ 371 Date: Sep. 21, 2018

(30) Foreign Application Priority Data
Mar. 24, 2016 (JP) 2016-060222

(51) Int. Cl. G02F 1/1337; G02F 1/1339; G02F 1/13357; C09K 19/54; C09K 19/30; C09K 19/42

(52) U.S. Cl. CPC G02F 1/133711; G02F 1/1339; C09K 19/42; C09K 19/54; C09K 19/30; G02F 1/133602

(57) ABSTRACT

A liquid crystal cell includes a pair of substrates, a liquid crystal layer, and a sealant. The pair of substrates includes opposing surfaces on which a photo-alignment film is provided. The liquid crystal layer is interposed between the substrates. The sealant is interposed between the substrates so as to surround the liquid crystal layer. The photo-alignment film contains a polymer having a polyamic acid as a main chain and a photo-functional group. The liquid crystal layer contains: a first liquid crystal compound having an unsaturated bond; and a second liquid crystal compound containing at least one compound selected from the group consisting of: a compound represented by a formula (I): A1-CnF2nB-A2; and a compound represented by a formula (II): A1-BCnF2n+1, where n, A1, A2 and B are as defined herein.

### TECHNICAL FIELD

The present invention relates to a liquid crystal cell and a liquid crystal display.

### BACKGROUND ART

A liquid crystal display includes a liquid crystal panel as a display unit that displays information such as images. The liquid crystal panel mainly includes a liquid crystal cell in which a liquid crystal layer is sealed between a pair of substrates, and a pair of polarizers attached to both surfaces of the liquid crystal cell. When an electric field is applied to the liquid crystal layer, the alignment of a liquid crystal compound in the liquid crystal layer is controlled to control the amount of light passing through the liquid crystal panel.

A frame-like sealant is interposed between the substrates of such a liquid crystal panel (liquid crystal cell) so as to surround the liquid crystal layer.

Each of the pair of substrates has an alignment film provided on its surface that is in contact with the liquid crystal layer. As the alignment film, for example, a polyamic acid-based alignment film (so-called photo-alignment film) is used that has a photo-functional group such as an azobenzene group.

As the liquid crystal compound used for the liquid crystal panel (liquid crystal cell), for example, a liquid crystal compound disclosed in Patent Document 1 is known that has an unsaturated bond such as an alkenyl group and is excellent in response performance.

### RELATED ART DOCUMENT

### Patent Document

Patent Document 1: Japanese Unexamined Patent Application Publication No. 2012-7168

### Problem to be Solved by the Invention

In the case of a liquid crystal panel having the above-described photo-alignment film as an alignment film and a liquid crystal layer containing the above-described liquid crystal compound having an unsaturated bond, its voltage holding ratio may reduce with time. When the voltage holding ratio of the liquid crystal panel reduces, it is impossible to perform normal alignment control of the liquid crystal compound, and therefore display defects, such as spots and unevenness, may occur in images displayed on the liquid crystal panel (i.e., so-called burn-in may occur on the liquid crystal panel).

It is assumed that in this type of liquid crystal panel, radicals may be stably present in the liquid crystal layer, and the radicals act on the liquid crystal compound in the liquid crystal layer, so that an ionic compound (conductive substance) that causes a reduction in voltage holding ratio is generated in the liquid crystal layer.

The main source of radicals present in the liquid crystal layer is considered to be polyamic acid that is used for a photo-alignment film and has a photo-functional group. Usually, this type of photo-alignment film hardly dissolves into the liquid crystal layer. However, it is assumed that when the hydrophilicity of the liquid crystal layer increases due to, for example, the entry of water (moisture) from the outside into the liquid crystal layer, part of the photo-alignment film gradually dissolves into the liquid crystal layer even though its amount is very small. The component of the photo-alignment film that has dissolved into the liquid crystal layer contains a photo-functional group, such as an azobenzene group, as a source of radicals. Therefore, it is considered that when such a radical source is irradiated with light (e.g., light emitted from a backlight provided in a liquid crystal display), radicals are generated in the liquid crystal layer. It is assumed that radicals generated in the liquid crystal layer can be stably present in the liquid crystal layer to some extent due to, for example, transfer to the alkenyl group of the liquid crystal compound.

It is considered that water (moisture) enters from the outside into the liquid crystal layer mainly through a sealant. Particularly, in recent years, there has been an increasing demand for narrow bezel type liquid crystal panels. This requires a reduction in the line width of a sealant. Therefore, it can be said that the probability that water penetrates through a sealant increases.

As a sealant, a mixed resin of an epoxy resin and an acrylic resin is sometimes used. This type of sealant is used in, for example, a one-drop-fill (ODF) process, and contains an acrylic resin obtained by photo-polymerizing an acrylic monomer with the use of a photo-radical polymerization initiator and an epoxy resin obtained by thermally polymerizing a curing agent (amine type) and an epoxide monomer. This type of epoxide monomer is amphiphilic, and therefore easily captures water that has entered from the outside and can move throughout the sealant together with water. Therefore, the epoxide monomer remaining in the sealant makes it easy for water to enter the liquid crystal layer. This type of sealant is a so-called solventless type sealant, and therefore unreacted components are likely to remain in the sealant. Therefore, it can be said that this type of sealant particularly makes it easy for moisture to enter the liquid crystal layer.

The ratio of the acrylic resin in the sealant may be increased by reducing the ratio of the epoxy resin that causes the entry of water. However, when the ratio of the acrylic resin increases, the amount of the photo-radical polymerization initiator to be used increases, and therefore the amount of the photo-radical polymerization initiator that dissolves into the liquid crystal layer also increases. In this case, such a photo-radical polymerization initiator functions as a new radical source in the liquid crystal layer. Further, in this case, the ratio of the unreacted acrylic monomer (hydrophobic) that is to enter the liquid crystal layer increases. Therefore, there is a fear that the entry of such an acrylic monomer into the liquid crystal layer also makes it impossible to maintain normal alignment control of the liquid crystal compound.

### DISCLOSURE OF THE PRESENT INVENTION

It is an object of the present invention to provide a liquid crystal cell whose voltage holding ratio is prevented from being reduced, and a liquid crystal display.

### Means for Solving the Problem

The present invention is directed to a liquid crystal cell including: a pair of substrates facing each other and including opposing surfaces on at least one of which a photo-alignment film is provided; a liquid crystal layer interposed between the substrates; and a sealant interposed between the substrates so as to surround the liquid crystal layer. The photo-alignment film contains a polymer having a polyamic acid as a main chain and a photo-functional group. The liquid crystal layer contains: a first liquid crystal compound having an unsaturated bond; and a second liquid crystal compound containing at least one compound selected from the group consisting of: a compound represented by a formula (I), A¹-CₙF₂ₙB-A²; and a compound represented by a formula (II), A¹-BCₙF₂ₙ₊₁, where n is an integer of 1 to 6, A¹ and A² are each independently at least one substituent group selected from the group consisting of a phenyl group, a phenylene group, a naphthyl group, a naphthylene group, a cyclohexyl group, and a cyclohexylene group, at least one hydrogen atom contained in the substituent group may be substituted with an F atom, a Cl atom, a Br atom, a methyl group, or an ethyl group, and B is an O atom or a direct bond.

In the liquid crystal cell, the second liquid crystal compound may contain at least one structure selected from the group consisting of structures represented by the following chemical formulas (1-1) to (1-4).

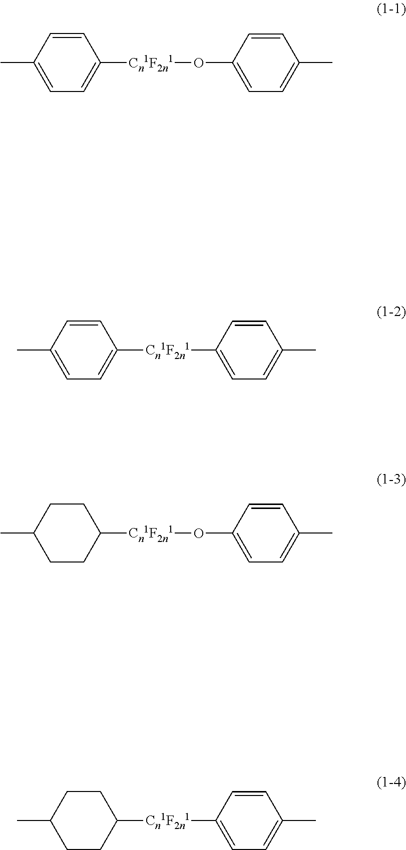

In the chemical formulas (1-1) to (1-4), n¹ is an integer of 1 to 6, and at least one hydrogen atom contained in an aromatic ring or an aliphatic ring in each of the chemical formulas (1-1) to (1-4) may be substituted with an F atom, a Cl atom, a Br atom, a methyl group, or an ethyl group.

In the liquid crystal cell, the second liquid crystal compound may contain at least one structure selected from the group consisting of structures represented by the following chemical formulas (2-1) and (2-2).

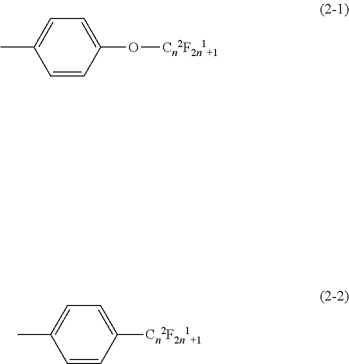

In the chemical formulas (2-1) and (2-2), n² is an integer of 1 to 6, and at least one hydrogen atom contained in an aromatic ring in each of the chemical formulas (2-1) and (2-2) may be substituted with an F atom, a Cl atom, a Br atom, a methyl group, or an ethyl group.

In the liquid crystal cell, the first liquid crystal compound may be at least one selected from the group consisting of alkenyl group-containing compounds represented by the following chemical formulas (3-1) to (3-4).

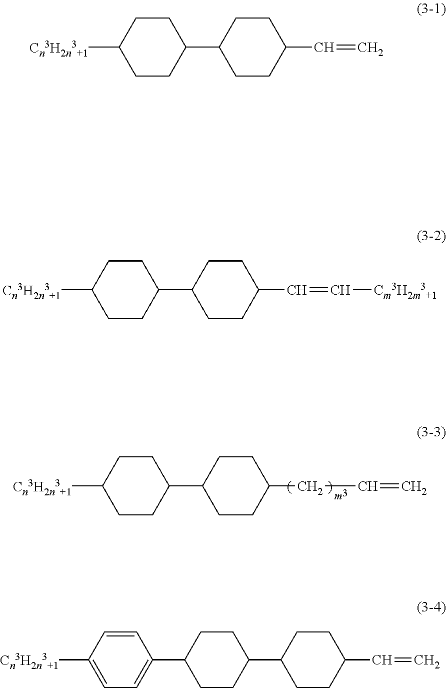

In the chemical formulas (3-1) to (3-4), n³ and m³ are the same or different integers of 1 to 6.

In the liquid crystal cell, the liquid crystal layer may preferably have a liquid crystal phase-isotropic phase transition temperature (T_{NI}) of 90° C. or higher.

In the liquid crystal cell, the sealant may contain a compound represented by the following chemical formula (4).

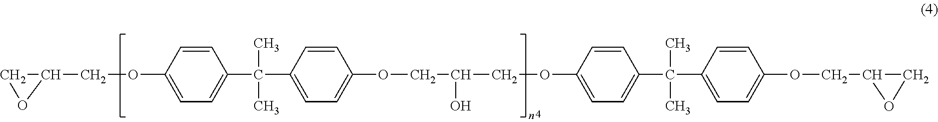

In the chemical formula (4), n⁴ is an integer of 0 to 3.

In the liquid crystal cell, the sealant may have a portion having a line width of 1.0 mm or less.

In the liquid crystal cell, the sealant may contain a polymer of an acrylic monomer and a photo-radical polymerization initiator used for polymerization of the acrylic monomer.

In the liquid crystal cell, the photo-alignment film may be a horizontal alignment film, and the first liquid crystal compound and the second liquid crystal compound in the liquid crystal layer may be aligned substantially parallel to the alignment film.

In the liquid crystal cell, the photo-alignment film may be a vertical alignment film, and the first liquid crystal compound and the second liquid crystal compound in the liquid crystal layer may be aligned substantially vertically to the alignment film.

A liquid crystal alignment mode of the liquid crystal cell may be any one of a TN mode, an ECB mode, an IPC mode, an FFS mode, a VA mode, a VATN mode, and a UV2A mode.

The present invention is also directed to a liquid crystal display including: a liquid crystal panel including the liquid crystal cell; and a backlight that supplies light to the liquid crystal panel.

### Advantageous Effect of the Invention

According to the present invention, it is possible to provide a liquid crystal cell and a liquid crystal display whose voltage holding ratio is prevented from being reduced.

### BRIEF DESCRIPTION OF THE DRAWINGS

FIG. 1 is an explanatory diagram that schematically shows the structure of a liquid crystal display according to one embodiment of the present invention.

FIG. 2 is an explanatory diagram that schematically shows the structure of a liquid crystal cell.

### MODE FOR CARRYING OUT THE INVENTION

(Liquid Crystal Display)

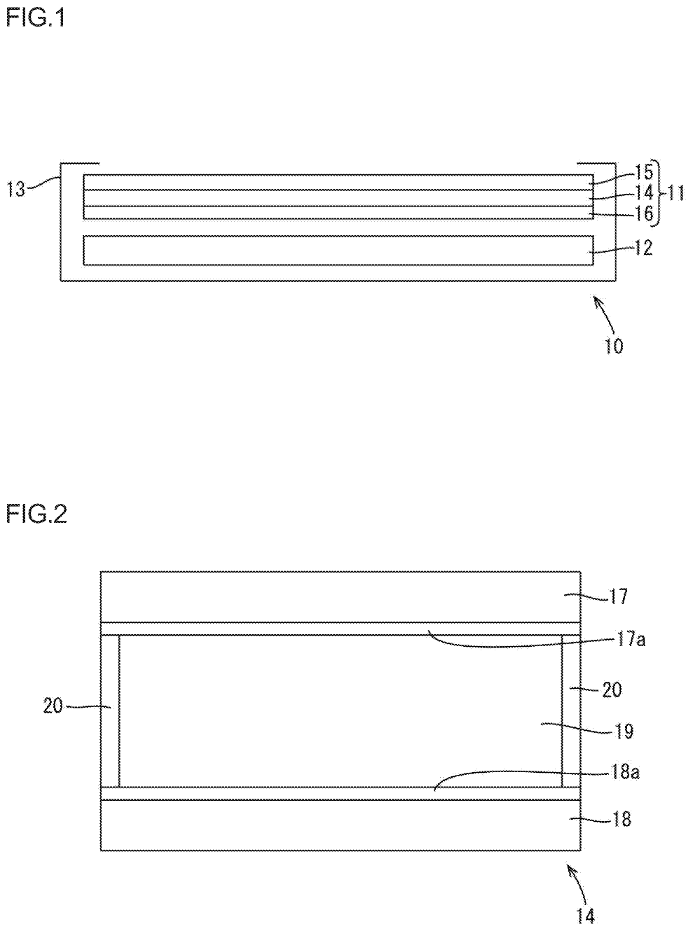

Hereinbelow, an embodiment of the present invention will be described with reference to the drawings. FIG. 1 is an explanatory diagram that schematically shows the structure of a liquid crystal display 10 according to one embodiment of the present invention. The liquid crystal display 10 mainly includes a liquid crystal panel 11 and a backlight 12 that supplies light to the liquid crystal panel 11. The liquid crystal panel 11 and the backlight 12 are accommodated in a predetermined casing 13.

The liquid crystal panel 11 mainly includes a liquid crystal cell 14 and a pair of polarizers 15 and 16 attached to both surfaces of the liquid crystal cell 14, respectively.

(Liquid Crystal Cell)

FIG. 2 is an explanatory diagram that schematically shows the structure of the liquid crystal cell. The liquid crystal cell 14 includes a pair of substrates 17 and 18 facing each other and having photo-alignment films 17a and 18b provided on their respective opposing surfaces, a liquid crystal layer 19 interposed between the substrates 17 and 18, and a sealant 20 interposed between the substrates 17 and 18 so as to surround the liquid crystal layer 19. The substrate 17, which is one of the pair of substrates 17 and 18, is an array substrate 17, and the other substrate 18 is a counter substrate 18.

(Substrate)

The array substrate 17 is a transparent support substrate (made of, for example, glass) having thin film transistors (TFTs) and the like formed thereon. The array substrate 17 has a photo-alignment film 17a formed on its surface (opposing surface) opposing to the other counter substrate 18. The counter substrate 18 is a transparent support substrate (made of, for example, glass) having color filters (CFs) and the like formed thereon. The counter substrate 18 has a photo-alignment film 18a formed on its surface (opposing surface) opposing to the other array substrate 17.

When the liquid crystal alignment mode of the liquid crystal cell 14 is a horizontal alignment mode, pixel electrodes made of transparent conductive films such as ITO and a counter electrode made of a transparent conductive film are formed on the array substrate 17. On the other hand, when the liquid crystal alignment mode of the liquid crystal cell 14 is a vertical alignment mode, pixel electrodes are formed on the array substrate 17, and a counter electrode is formed on the counter substrate 18.

(Photo-Alignment Film)

The photo-alignment film is a polymer film that contains a polymer having polyamic acid represented by the following chemical formula (5) as a main chain and a photo-functional group and that has been subjected to photo-alignment treatment by irradiation with polarized light. The photo-alignment film that has been subjected to photo-alignment treatment has the function of aligning a liquid crystal compound such that the liquid crystal compound maintains a predetermined angle to a polarizing direction.

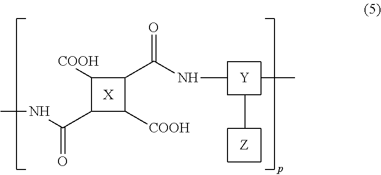

In the formula (5), when having a photo-functional group, X has a structure represented by any one of the following chemical formulas (6-1) to (6-4), when having a photo-functional group, Y has a structure represented by any one of the following chemical formulas (7-1) to (7-8), and when having a photo-functional group, Z has a structure represented by any one of the following chemical formulas (8-1) to (8-5).

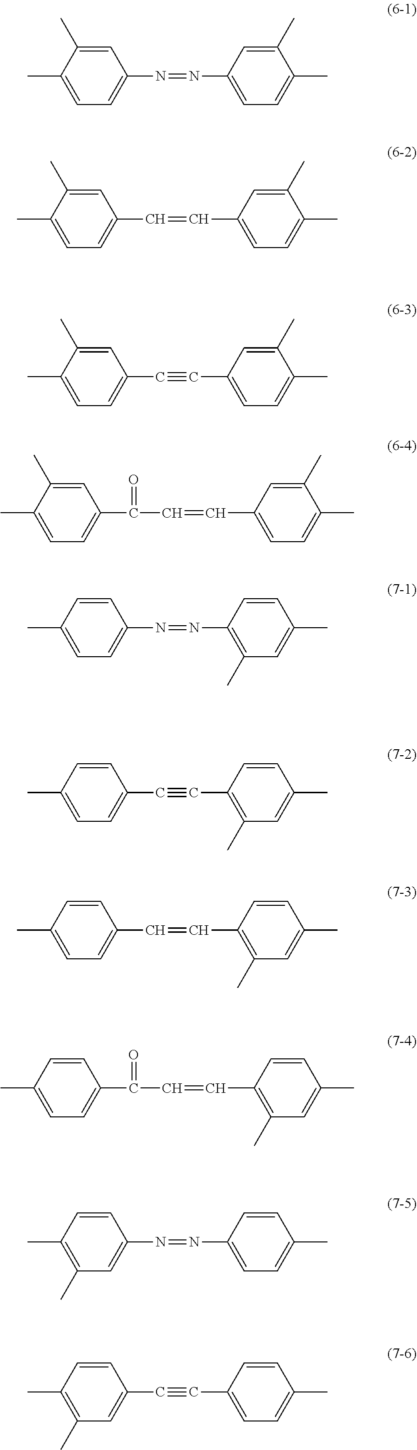

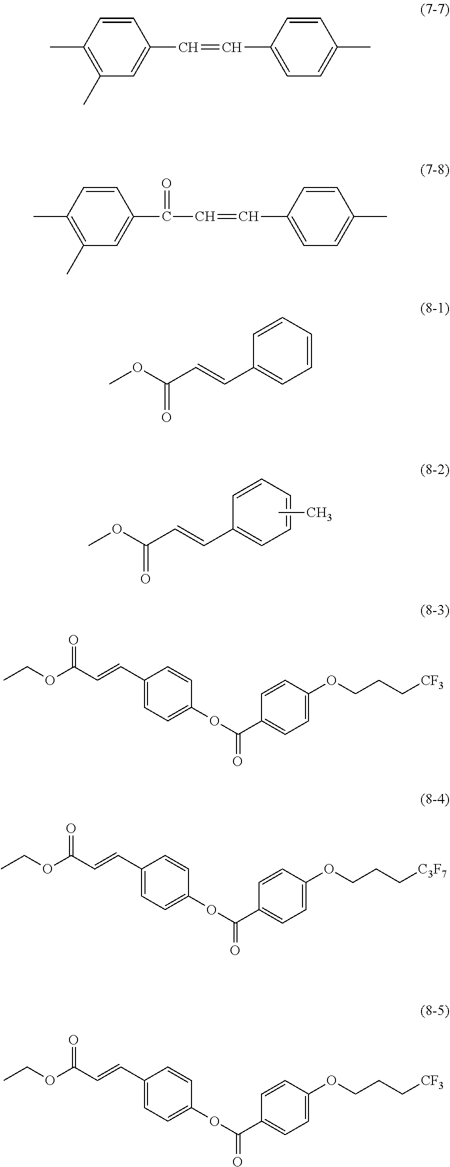

In the above chemical formula (5), when having a photo-functional group, as described above, X has a structure containing any one of an azobenzene group, a tolane group, a stilbene group, and a chalcone group. In the above chemical formula (5), when having a photo-functional group, as described above, Y has a structure containing any one of an azobenzene group, a tolane group, a stilbene group, and a chalcone group. In the above chemical formula (5), when having a photo-functional group, as described above, Z (side chain) has a structure containing a cinnamate group.

It is to be noted that a specific structure of the polymer represented by the above chemical formula (5) constituting the photo-alignment film is appropriately selected depending on, for example, a direction in which a liquid crystal compound (a first liquid crystal compound and a second liquid crystal compound) that will be described later is to be aligned (e.g., horizontal alignment or vertical alignment).

In the above chemical formula (5), when X has a structure other than a photo-functional group, the structure of X is not particularly limited, and examples thereof include structures represented by the following chemical formulas (9-1) to (9-8).

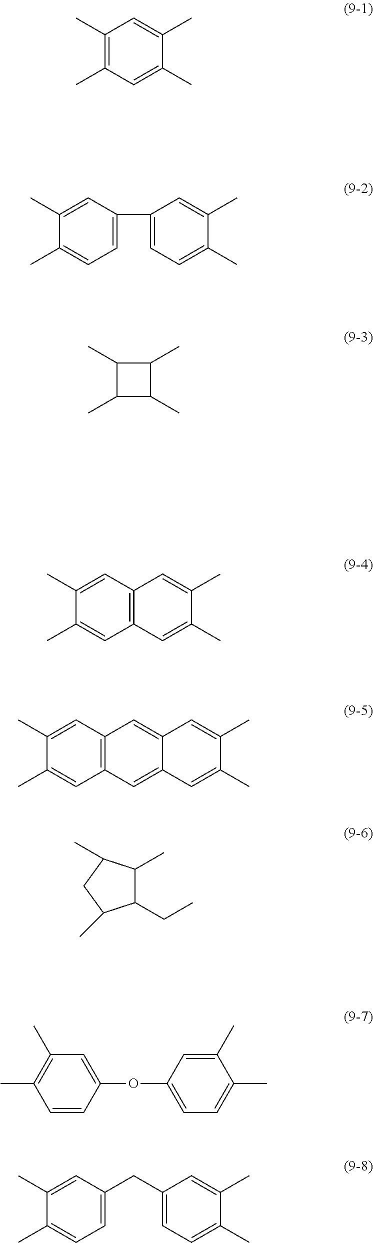

In the chemical formula (5), when Y has a structure other than a photo-functional group, the structure of Y is not particularly limited, and examples thereof include structures represented by the following chemical formulas (10-1) to (10-8).

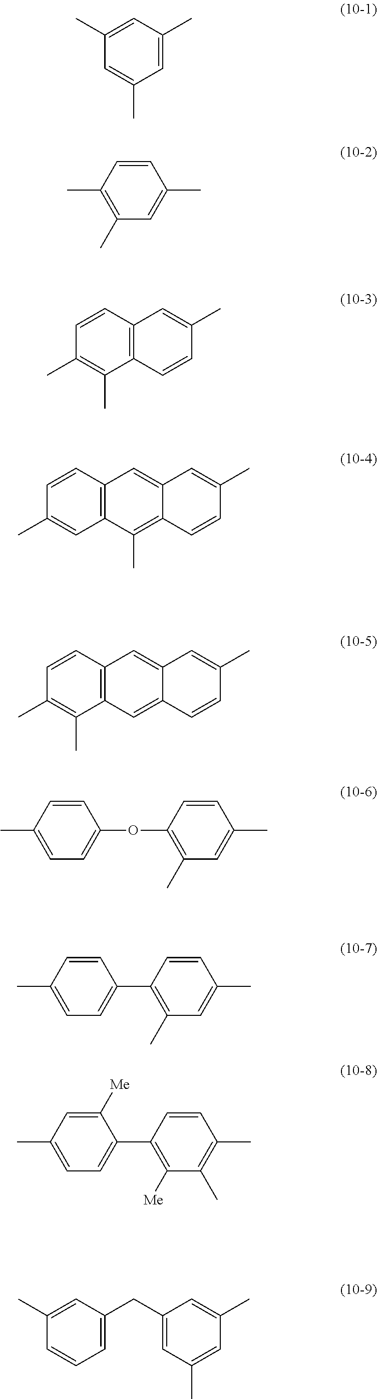

In the chemical formula (5), when Z has a structure other than a photo-functional group, the structure of Z is not particularly limited as long as the objects of the present invention are not impaired.

As shown in FIG. 2, in the present embodiment, the photo-alignment films 17a and 18a are formed on the surfaces (opposing surfaces) of both of the pair of substrates 17 and 18, respectively. It is to be noted that in another embodiment, a photo-alignment film may be formed on only the opposing surface of at least one of the pair of substrates.

In the process of producing the photo-alignment film, first, an uncured aligning agent having fluidity and containing polyamic acid represented by the above chemical formula (5) is applied onto the surface (opposing surface) of each of the substrates 17 and 18 using a coater. The coated aligning agent is preliminarily fired (e.g., heat treatment at 80° C. for 2 minutes), and then irradiated with predetermined linear polarized light to perform photo-alignment treatment. After the photo-alignment treatment, the coated aligning agent is finally fired (e.g., heat treatment at 110° C. for 20 minutes followed by heat treatment at 230° C. for 20 minutes) to obtain a photo-alignment film having the property of aligning a liquid crystal compound in a predetermined direction. It is to be noted that when the coated aligning agent is preliminarily or finally fired, part of the polyamic acid is appropriately imidized.

(Sealant)

The sealant is interposed between the substrates 17 and 18 so as to surround the liquid crystal layer in order to seal the liquid crystal layer. The sealant also has the function of adhering the substrates 17 and 18 to each other. When the liquid crystal cell is viewed in plan view, the sealant has a frame-like shape so as to surround the liquid crystal layer.

The sealant is made of a cured product of a curable resin composition containing a curable resin. The curable resin is not particularly limited as long as it has an ultraviolet reactive functional group and a thermally reactive functional group. However, a curable resin having a (meth)acryloyl group and/or an epoxy group is suitably used, because when the curable resin composition is used as a sealant for use in a liquid crystal one-drop-fill process, a curing reaction quickly proceeds and excellent adhesion is achieved. Examples of such a curable resin include a (meth)acrylate and an epoxy resin. These resins may be used alone or in combination of two or more of them. In the present description, (meth)acrylic refers to acrylic or methacrylic.

The (meth)acrylate is not particularly limited, and examples thereof include a urethane (meth)acrylate having a urethane bond and an epoxy (meth)acrylate derived from a compound having a glycidyl group and (meth)acrylic acid.

The urethane (meth)acrylate is not particularly limited, and examples thereof include derivatives of a diisocyanate, such as isophorone diisocyanate, and a reactive compound, such as acrylic acid or hydroxyethyl acrylate, that undergoes an addition reaction with an isocyanate. These derivatives may be chain-extended with caprolactone, a polyol, or the like. Examples of a commercially available products include: U-122P, U-340P, U-4HA, and U-1084A (all manufactured by Shin-Nakamura Chemical Co., Ltd.); and KRM7595, KRM7610, and KRM7619 (all manufactured by Daicel-UCB Company, Ltd.).

The epoxy (meth)acrylate is not particularly limited, and examples thereof include epoxy (meth)acrylates derived from an epoxy resin, such as a bisphenol A type epoxy resin or propylene glycol diglycidyl ether, and (meth)acrylic acid. Examples of a commercially available product include: EA-1020, EA-6320, and EA-5520 (all manufactured by Shin-Nakamura Chemical Co., Ltd.); and epoxy ester 70PA and epoxy ester 3002A (all manufactured by Kyoeisha Chemical Co., Ltd.).

Examples of another (meth)acrylate include methyl methacrylate, tetrahydrofurfuryl methacrylate, benzyl methacrylate, isobornyl methacrylate, 2-hydroxyethyl methacrylate, glycidyl methacrylate, (poly)ethylene glycol dimethacrylate, 1,4-butanediol dimethacrylate, 1,6-hexanediol dimethacrylate, trimethylolpropane triacrylate, pentaerythritol triacrylate, and glycerin dimethacrylate.

Examples of the epoxy resin include a phenol novolac type epoxy resin, a cresol novolac type epoxy resin, a biphenyl novolac type epoxy resin, a trisphenol novolac type epoxy resin, a dicyclopentadiene novolac type epoxy resin, a bisphenol A type epoxy resin, a bisphenol F type epoxy resin, a 2,2′-diallylbisphenol A type epoxy resin, a bisphenol S type epoxy resin, a hydrogenated bisphenol A type epoxy resin, a propylene oxide adduct bisphenol A type epoxy resin, a bipheny type epoxy resin, a naphthalene type epoxy resin, a resorcinol type epoxy resin, and a glycidyl amine.

Examples of commercially available products of such epoxy resins include: NC-3000S (manufactured by Nippon Kayaku Co., Ltd.) as a phenyl novolac type epoxy resin; EPPN-501H and EPPN-501H (all manufactured by Nippon Kayaku Co., Ltd.) as trisphenol novolac type epoxy resins; NC-7000L (manufactured by Nippon Kayaku Co., Ltd.) as a dicyclopentadiene novolac type epoxy resin; EPICLON 840S and EPICLON 850CRP (all manufactured by DIC Corporation) as bisphenol A type epoxy resins; Epikote 807 (manufactured by Japan Epoxy Resin Co., Ltd.) and EPICLON 830 (manufactured by DIC Corporation) as bisphenol F type epoxy resins; RE310NM (manufactured by Nippon Kayaku Co., Ltd.) as a 2,2′-diallylbisphenol A type epoxy resin; EPICLON 7015 (manufactured by DIC Corporation) as a hydrogenated bisphenol type epoxy resin; Epoxy Ester 3002A (manufactured by Kyoeisha Chemical Co., Ltd.) as a propylene oxide adduct bisphenol A type epoxy resin; Epikote YX-4000H and YL-6121H (all manufactured by Japan Epoxy Resin Co., Ltd.) as biphenyl type epoxy resins; EPICLON HP-4032 (manufactured by DIC Corporation) as a naphthalene type epoxy resin; Denacol EX-201 (manufactured by Nagase ChemteX Corporation) as a resorcinol type epoxy resin; EPICLON 430 (manufactured by DIC Corporation) and Epikote 630 (manufactured by Japan Epoxy Resin Co., Ltd.) as glycidyl amines.

The curable resin suitably used for the curable resin composition may be an epoxy/(meth)acrylic resin having at least one (meth)acrylic group and at least one epoxy group in one molecule. Examples of the epoxy/(meth)acrylic resin include: a compound obtained by reacting some of epoxy groups of the above-described epoxy resin with (meth)acrylic acid in the presence of a basic catalyst according to an ordinary method; a compound obtained by reacting 1 mol of a bifunctional or higher-functional isocyanate with ½ mol of a (meth)acrylic monomer having a hydroxyl group and then with ½ mol of glycidol; and a compound obtained by reacting a (meth)acrylate having an isocyanate group with glycidol. An example of a commercially available product of the epoxy/(meth)acrylic resin includes UVAC1561 (manufactured by Daicel-UCB Company, Ltd.).

Further, the curable resin composition contains a photopolymerization initiator. The photopolymerization initiator is not particularly limited as long as it polymerizes the curable resin by ultraviolet irradiation. Examples of the photopolymerization initiator include compounds represented by the following chemical formula (11) and chemical formula (12).

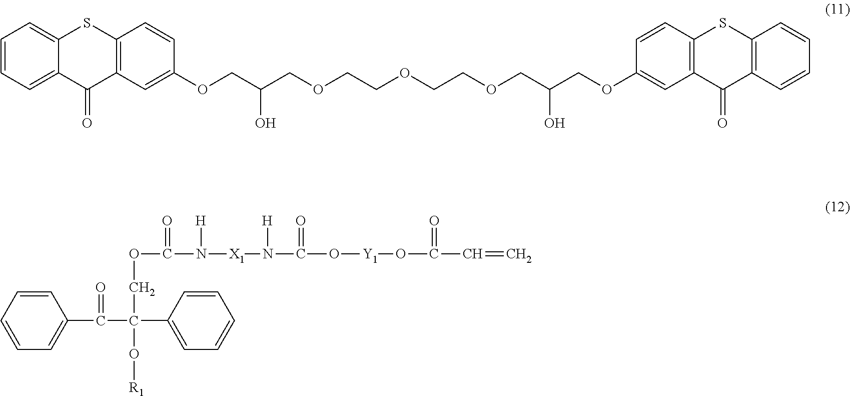

In the formula (12), RI represents hydrogen or an aliphatic hydrocarbon residue having 4 carbon atoms or less, X¹ represents a residue of a bifunctional isocyanate derivative having 13 carbon atoms or less, Y¹ represents an aliphatic hydrocarbon residue having 4 carbon atoms or less or a residue whose atomic ratio between carbon and oxygen constituting it is 3 or less. If X¹ is a residue of a bifunctional isocyanate derivative having more than 13 carbon atoms, there is a case where the photopolymerization initiator easily dissolves in a liquid crystal, and if Y¹ is an aliphatic hydrocarbon group having more than 4 carbon atoms or a residue whose atomic ratio between carbon and oxygen exceeds 3, there is a case where the photopolymerization initiator easily dissolves in a liquid crystal.

Examples of the photopolymerization initiator include “Irgacure 651”, “Irgacure 189”, and “Irgacure-OXE01” (all manufactured by BASF Japan Ltd.).

Further, the curable resin composition contains a thermal curing agent. The thermal curing agent is used to thermally react a thermally reactive functional group in the curable resin to perform crosslinking, and has a role in improving the adhesion and moisture resistance of the cured curable resin composition. The thermal curing agent is not particularly limited, but preferably contains an amine having excellent low-temperature reactivity and/or a thiol group, because when used as a sealant for use in a one-drop-fill process, the curable resin composition according to the present invention is cured at a curing temperature of 100 to 120° C. Examples of such a thermal curing agent include, but are not limited to, hydrazide compounds such as 1,3-bis[hydrazinocarbonoethyl-5-isopropyl hydantoin] and adipic dihydrazide, dicyandiamide, guanidine derivatives, 1-cyanoethyl-2-phenylimidazole, N-[2-(2-methyl-1-imidazolyl)ethyl]urea, 2,4-diamino-6-[2′-methylimidazolyl-(1′)]-ethyl-s-triazine, N,N′-bis(2-methyl-1-imidazolylethyl)urea, N,N′-(2-methyl-1-imidazolylethyl)-adipoamide, 2-phenyl-4-methyl-5-hydroxymethyl imidazole, 2-imidazoline-2-thiol, 2,2′-thiodiethanethiol, and addition products of various amines and epoxy resins. These thermal curing agents may be used alone or in combination of two or more of them.

The line width of the sealant is not particularly limited. For example, the sealant may have a portion having a line width of 1.0 mm or less.

(Liquid Crystal Layer)

The liquid crystal layer contains a first liquid crystal compound and a second liquid crystal compound shown below as a liquid crystal compound (liquid crystal molecules).

The first liquid crystal compound is a liquid crystal compound having an unsaturated bond such as an alkenyl group, and is, for example, at least one selected from the group consisting of compounds having an alkenyl group and represented by the following chemical formulas (3-1) to (3-4).

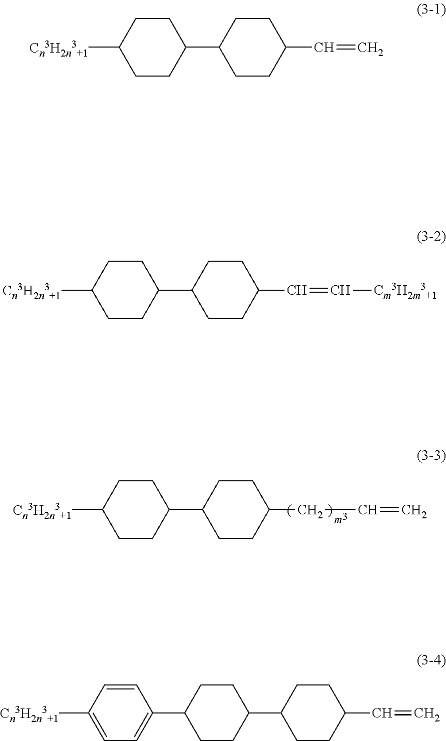

In the chemical formulas (3-1) to (3-4), n³ and m³ are the same or different integers of 1 to 6.

The second liquid crystal compound contains at least one compound selected from the group consisting of a compound represented by the formula (I), A¹-CₙF₂ₙB-A² and a compound represented by the formula (II), A¹-BCₙF₂ₙ₊₁.

In the formulas (I) and (II), n is an integer of 1 to 6. A¹ and A² are each independently at least one substituent group selected from the group consisting of a phenyl group, a phenylene group, a naphthyl group, a naphthylene group, a cyclohexyl group, and a cyclohexylene group, and at least one hydrogen atom contained in the substituent group may be substituted with an F atom, a Cl atom, a Br atom, a methyl group, or an ethyl group. B represents an O atom or a direct bond.

The second liquid crystal compound may contain at least one structure selected from the group consisting of structures represented by the following chemical formulas (1-1) to (1-4).

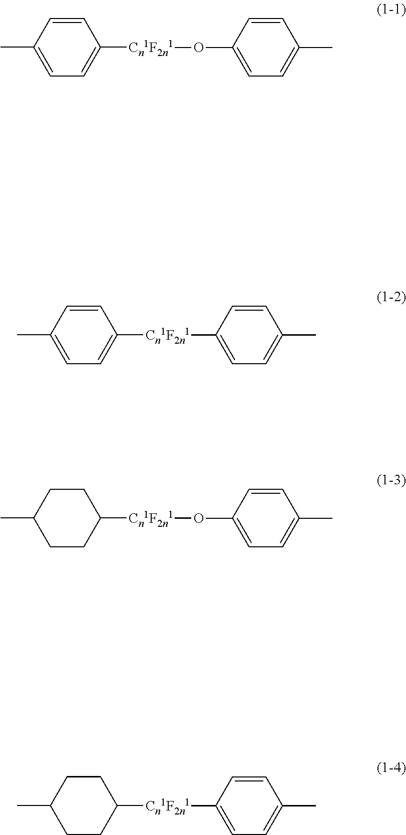

In the chemical formulas (1-1) to (1-4), n¹ is an integer of 1 to 6. In each of the chemical formulas, at least one hydrogen atom contained in an aromatic ring or an aliphatic ring may be substituted with an F atom, a Cl atom, a Br atom, a methyl group, or an ethyl group. From the viewpoint of increasing the hydrophobicity of the liquid crystal layer, the at least one hydrogen atom is particularly preferably substituted with an F atom (fluorine group).

The second liquid crystal compound may contain at least one structure selected from the group consisting of structures represented by the following chemical formulas (2-1) and (2-2).

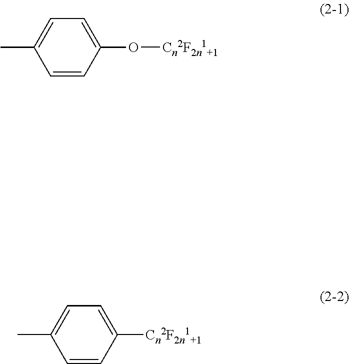

In the chemical formulas (2-1) and (2-2), n² is an integer of 1 to 6. In each of the chemical formulas, at least one hydrogen atom contained in an aromatic ring may be substituted with an F atom, a Cl atom, a Br atom, a methyl group, or an ethyl group. From the viewpoint of increasing hydrophobicity in the liquid crystal layer, the at least one hydrogen atom is particularly preferably substituted with an F atom (fluorine group).

When at least one hydrogen atom contained in an aromatic group in each of the above chemical formulas (1-1) to (1-4) and (2-1) and (2-2) is substituted with an F atom or the like, the hydrophobicity of the second liquid crystal compound increases, and therefore the hydrophobicity of the entire liquid crystal layer also increases. As described above, when the liquid crystal layer contains the second liquid crystal compound, its hydrophobicity can be made higher than when the liquid crystal layer does not contain the second liquid crystal compound, and therefore moisture is less likely to enter the liquid crystal layer from the outside.

As will be shown in Examples later, the position, type, and number of substituent groups such as an F atom (fluorine group) in each of the above chemical formulas (1-1) to (1-4) and (2-1) and (2-2) are appropriately selected depending on, for example, a desired liquid crystal alignment mode (e.g., horizontal alignment mode or vertical alignment mode) such that the second liquid crystal compound has a positive dielectric constant anisotropy or a negative anisotropic dielectricity.

It is to be noted that a liquid crystal compound having a positive dielectric constant anisotropy is used in, for example, a horizontal alignment mode or a twisted nematic (TN) mode. The horizontal alignment mode is a mode in which a liquid crystal compound having a positive dielectric constant anisotropy is horizontally aligned with respect to the surface of a substrate. Specific examples of the horizontal alignment mode include an in-plane switching (IPS) mode and a fringe field switching (FFS) mode in which a horizontal electric field is applied to a liquid crystal layer.

The TN mode is a mode in which a liquid crystal compound having a positive dielectric constant anisotropy is aligned so as to be twisted by 90° when viewed from the direction of the normal to a substrate.

On the other hand, a liquid crystal compound having a negative dielectric constant anisotropy is used in, for example, a vertical alignment (VA) mode. The vertical alignment mode is a mode in which a liquid crystal compound having a negative dielectric constant anisotropy is aligned vertically to the surface of a substrate.

The second liquid crystal compound content (wt %) of a liquid crystal material (the first liquid crystal compound and the second liquid crystal compound) constituting the liquid crystal layer is preferably 5 to 40%, and more preferably 15 to 30%. When the second liquid crystal compound content (wt %) is within the above range, the liquid crystal layer can easily have high hydrophobicity, and the TN of the liquid crystal layer, which will be described later, can be easily set to 90° C. or higher.

The liquid crystal material (the first liquid crystal compound and the second liquid crystal compound) constituting the liquid crystal layer preferably has a liquid crystal phase-isotropic phase transition temperature (T_{NI}) (° C.) of 90° C. or higher. When the liquid crystal material (the first liquid crystal compound and the second liquid crystal compound) constituting the liquid crystal layer has a T_{NI} of 90° C. or higher, for example, the viscosity (fluidity) of the liquid crystal layer can be reduced when the temperature of the liquid crystal cell (liquid crystal panel) increases due to irradiation of light emitted from a backlight. Therefore, even if moisture penetrates through the sealant into the liquid crystal layer from the outside, diffusion of the moisture in the liquid crystal layer is prevented. As a result, hydrophilization of the liquid crystal layer and dissolution of the photo-alignment film into the liquid crystal layer are prevented.

The T_{NI} of the liquid crystal material (the first liquid crystal compound and the second liquid crystal compound) is determined by, for example, analyzing the thermal behavior of the liquid crustal material with the use of a differential scanning calorimeter (DSC).

The liquid crystal alignment mode (display mode) of the liquid crystal cell is not particularly limited as long as the objects of the present invention are not impaired, and examples thereof include a TN mode, an IPS mode, an FFS mode, a VA mode, an ECB (Electrically Controlled Birefringence) mode, a VATN (Vertical Alignment Twisted Nematic) mode, and a UV2A (Ultra-violet induced Multi-domain Vertical Alignment) mode.

### EXAMPLES

Hereinbelow, the present invention will be described in more detail on the basis of examples. It is to be noted that the present invention is not limited by these examples.

### Example 1: FFS Mode

(Production of Liquid Crystal Cell)

An array substrate for FFS mode having a glass substrate and TFTs, pixel electrodes, and the like formed on the glass substrate and a counter substrate for FFS mode (without electrode) having a glass substrate and color filters and the like formed on the glass substrate were prepared. An aligning agent for horizontal alignment containing polyamic acid represented by the following chemical formula (13) was applied onto the substrate surface of each of the array substrate and the counter substrate by spin coating, and the coated material was preliminarily fired by heating at 80° C. for 2 minutes. Then, the coated material was subjected to photo-alignment treatment by irradiation with linear polarized light (including ultraviolet light with a wavelength of 310 nm to 370 nm) at 2 J/cm² from a predetermined direction. Then, the coated material after photo-alignment treatment was finally fired by heating at 110° C. for 20 minutes and then by heating at 230° C. for 20 minutes. In this way, a photo-alignment film was formed on the substrate surface of each of the array substrate and the counter substrate.

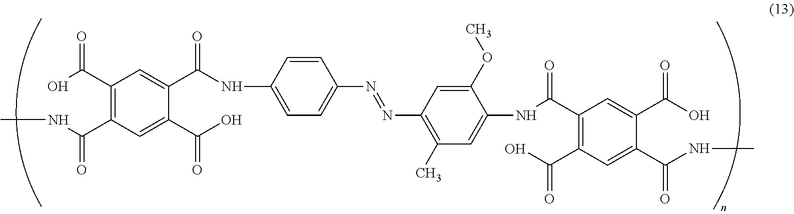

Then, an uncured sealant for ODF was applied onto the oriented alignment film of the array substrate so as to have a frame shape with the use of a dispenser. The uncured sealant for ODF has ultraviolet curability and thermal curability, and includes a mixed composition containing: a photopolymerization initiator and a (meth)acrylic monomer used for photopolymerization (radical polymerization); and an epoxy monomer and an amine curing agent used for thermal polymerization. As the photopolymerization initiator, “IRGACURE 651” (trade name, manufactured by BASF Japan Ltd.) was used. As the epoxy monomer, an epoxy compound represented by the following chemical formula (14) was used.

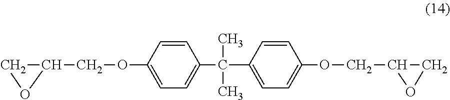 [SMILES: CC(C)(c1ccc(OCC2CO2)cc1)c1ccc(OCC2CO2)cc1]

Then, a liquid crystal material was dropped in a predetermined position on the photo-alignment film of the counter substrate. The liquid crystal material contains a first liquid crystal compound having an unsaturated bond and a second liquid crystal compound having a positive dielectric constant anisotropy and represented by the following chemical formula (15). The second liquid crystal compound content of the liquid crystal material is 1 wt %.

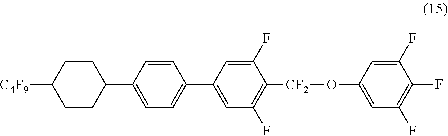

The first liquid crystal compound was appropriately selected from alkenyl group-containing liquid crystal compounds represented by the chemical formulas (3-1) to (3-4) in the description of the present application such that the entire liquid crystal material had a T_{NI} (liquid crystal phase-isotropic phase transition temperature) of 90° C.

Then, the array substrate and the counter substrate were bonded together under vacuum to form a laminate, and the sealant of the laminate was optically cured by irradiation with ultraviolet light (including ultraviolet light of 300 nm to 400 nm). Further, the laminate was heated at 130° C. for 40 minutes to thermally cure the sealant to seal the liquid crystal material and to perform re-alignment treatment to allow the liquid crystal material to be in its isotropic phase. Then, the laminate was cooled to room temperature to obtain an FFS mode liquid crystal cell. It is to be noted that the line width of the thinnest portion of the sealant was 1.0 mm or less.

### Example 2: FFS Mode

A liquid crystal cell of Example 2 was produced in the same manner as in Example 1 except that the second liquid crystal compound content of the liquid crystal material was changed to 3 wt %.

### Example 3: FFS Mode

A liquid crystal cell of Example 3 was produced in the same manner as in Example 1 except that the second liquid crystal compound content of the liquid crystal material was changed to 5 wt %.

### Comparative Example 1: FFS Mode

A liquid crystal cell of Comparative Example 1 was produced in the same manner as in Example 1 except that the second liquid crystal compound was not added to the liquid crystal material.

(High-Temperature and High-Humidity Test)

A high-temperature and high-humidity test was performed on each of the liquid crystal cells of Examples 1 to 3 and Comparative Example 1 in the following manner. The liquid crystal cell was placed on a lighted backlight unit in a tank at a temperature of 60° C. and a humidity of 95% and allowed to stand for 1000 hours. Before and after the liquid crystal cell was allowed to stand (i.e., at the start of the test and after 1000 hours from the start of the test), the voltage holding ratio (VHR) of the liquid crystal cell was measured. It is to be noted that the voltage holding ratio was measured using Model 6254 VHR measurement system (manufactured by TOYO Corporation) under the conditions of 1 V and 70° C. The

TABLE 1

| | VHR (%) AT | VHR (%) AFTER |
|---|---|---|
| | START OF TEST | 1000 HOURS |
| COMPARATIVE | 99.5 | 88.5 |
| EXAMPLE 1 (0 wt %) | | |
| EXAMPLE 1 (1 wt %) | 99.5 | 94.5 |
| EXAMPLE 2 (3 wt %) | 99.5 | 99.1 |
| EXAMPLE 3 (5 wt %) | 99.5 | 99.1 |

As shown in Table 1, the VHR of the liquid crystal cell of Comparative Example 1 whose liquid crystal material contained no second liquid crystal compound was reduced to the order of 80% after a lapse of 1000 hours from the start of the test. It is assumed that the reason for this is that moisture penetrated through the sealant into the liquid crystal layer (liquid crystal material) from the outside, and part of the alignment film dissolved into the liquid crystal layer due to the influence of the moisture that had entered the liquid crystal layer. The part of the alignment film that has dissolved into the liquid crystal layer contains an azobenzene group as a photo-functional group, and the azobenzene group is optically excited by light emitted from the backlight to generate a radical. The generated radical is transferred to the alkenyl group-containing first liquid crystal compound contained in the liquid crystal layer and therefore can stay in the liquid crystal layer for a long time. As a result, it is assumed that an ionic compound (conductive material) that causes a reduction in VHR was generated in the liquid crystal layer.

On the other hand, the VHR of each of the liquid crystal cells of Examples 1 to 3 whose liquid crystal layer contained the second liquid crystal compound was prevented from being significantly reduced after the high-temperature and high-humidity test (after 1000 hours). Particularly, the VHR of each of the liquid crystal cells of Examples 2 and 3 was hardly reduced after the high-temperature and high-humidity test (after 1000 hours) and was 99% or higher even after 1000 hours. It is assumed that the reason for this is that the liquid crystal layer had high hydrophobicity due to the fluorine group-containing second liquid crystal compound contained in the liquid crystal layer, and therefore the entry of moisture through the seal into the liquid crystal layer was prevented, and further, the dissolution of the polyamic acid-based photo-alignment film into the liquid crystal layer was prevented.

### Example 4: IPS Mode

(Production of Liquid Crystal Cell)

An array substrate for IPS mode having a glass substrate and TFTs, pixel electrodes, and the like formed on the glass substrate, and a counter substrate for IPS mode (without electrode) having a glass substrate and color filters and the like formed on the glass substrate were prepared. Similarly to Example 1, an aligning agent for horizontal alignment containing polyamic acid represented by the chemical formula (13) was applied onto the substrate surface of each of the array substrate and the counter substrate by spin coating, and the coated material was preliminarily fired by heating at 80° C. for 2 minutes. Then, the coated material was subjected to photo-alignment treatment by irradiation with linear polarized light (including ultraviolet light with a wavelength of 310 nm to 370 nm) at 5 J/cm² from a predetermined direction. Then, the coated material after photo-alignment treatment was finally fired by heating at 110° C. for 20 minutes and then by heating at 230° C. for 20 minutes. In this way, a photo-alignment film was formed on the substrate surface of each of the array substrate and the counter substrate.

Then, the same uncured sealant for ODF as used in Example 1 was applied onto the photo-alignment film of the array substrate so as to have a frame shape with the use of a dispenser.

Then, a liquid crystal material was dropped in a predetermined position on the photo-alignment film of the counter substrate. The liquid crystal material contains a first liquid crystal compound having an unsaturated bond and a second liquid crystal compound having a positive dielectric constant anisotropy and represented by the chemical formula (18). The second liquid crystal compound content of the liquid crystal material is 1 wt %.

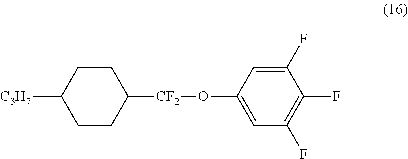

The first liquid crystal compound was appropriately selected from alkenyl group-containing liquid crystal compounds represented by the chemical formulas (3-1) to (3-4) in the description of the present application such that the entire liquid crystal material had a T_{NI} of 95° C.

Then, the array substrate and the counter substrate were bonded together under vacuum to form a laminate, and the sealant of the laminate was optically cured by irradiation with ultraviolet light (including ultraviolet light of 300 nm to 400 nm). Further, the laminate was heated at 130° C. for 40 minutes to thermally cure the sealant to seal the liquid crystal material and to perform re-alignment treatment to allow the liquid crystal material to be in its isotropic phase. Then, the laminate was cooled to room temperature to obtain an IPS mode liquid crystal cell. It is to be noted that the line width of the thinnest portion of the sealant was 1.0 mm or less.

[Verification of T_{NI}]

### Example 5: IPS Mode

A liquid crystal cell of Example 4 was produced in the same manner as in Example 4 except that the second liquid crystal compound content of the liquid crystal material was changed to 3 wt %.

### Example 6: IPS Mode

A liquid crystal cell of Example 6 was produced in the same manner as in Example 4 except that the second liquid crystal compound content of the liquid crystal material was changed to 5 wt %.

### Comparative Example 2: IPS Mode

A liquid crystal cell of Comparative Example 2 was produced in the same manner as in Example 4 except that the second liquid crystal compound was not added to the liquid crystal material.

(High-Temperature and High-Humidity Test)

A high-temperature and high-humidity test was performed on each of the liquid crystal cells of Examples 4 to 6 and Comparative Example 2 in the same manner as in Example 1. The voltage holding ratio (VHR) of each of the liquid crystal cells was measured before and after the liquid crystal cell was allowed to stand for 1000 hours (i.e., at the start of the test and after 1000 hours from the start of the test). The results are shown in Table 2.

TABLE 2

| | VHR (%) AT | VHR (%) AFTER |
|---|---|---|
| | START OF TEST | 1000 HOURS |
| COMPARATIVE | 99.5 | 88.5 |
| EXAMPLE 2 (0 wt %) | | |
| EXAMPLE 4 (1 wt %) | 99.5 | 95.2 |
| EXAMPLE 5 (3 wt %) | 99.5 | 99.0 |
| EXAMPLE 6 (5 wt %) | 99.5 | 99.1 |

As shown in Table 2, the VHR of the liquid crystal cell of Comparative Example 2 whose liquid crystal material contained no second liquid crystal compound was reduced to the order of 80% after a lapse of 1000 hours from the start of the test. On the other hand, similarly to Example 1, the VHR of each of the liquid crystal cells of Examples 4 to 6 whose liquid crystal layer contained the second liquid crystal compound was prevented from being significantly reduced after the high-temperature and high-humidity test (after 1000 hours). Particularly, the VHR of each of the liquid crystal cells of Examples 5 and 6 was hardly reduced after the high-temperature and high-humidity test (after 1000 hours) and was 99% or higher even after 1000 hours.

### Comparative Example 3: FFS Mode

A liquid crystal cell of Comparative Example 3 was produced in the same manner as in Example 3 except that the first liquid crystal compound was appropriately selected from alkenyl group-containing liquid crystal compounds represented by the chemical formulas (3-1) to (3-4) in the description of the present application such that the entire liquid crystal material had a T_{NI} of 70° C.

### Comparative Example 4: FFS Mode

A liquid crystal cell of Comparative Example 4 was produced in the same manner as in Example 3 except that the first liquid crystal compound was appropriately selected from alkenyl group-containing liquid crystal compounds represented by the chemical formulas (3-1) to (3-4) in the description of the present application such that the entire liquid crystal material had a T_{NI} of 80° C.

(High-Temperature and High-Humidity Test)

A high-temperature and high-humidity test was performed on each of the liquid crystal cells of Comparative Examples 4 and 5 in the same manner as in Example 1. The voltage holding ratio (VHR) of each of the liquid crystal cells was measured before and after the liquid crystal cell was allowed to stand for 1000 hours (i.e., at the start of the test and after 1000 hours from the start of the test). The results are shown in Table 3. The results of the liquid crystal cell of Example 3 whose T_{NI} of the entire liquid crystal material was 90° C. and second liquid crystal compound content was 5 wt % are also shown in Table 3.

TABLE 3

| | VHR (%) AT | VHR (%) AFTER |
|---|---|---|
| | START OF TEST | 1000 HOURS |
| COMPARATIVE EXAMPLE 3 | 99.5 | 92.0 |
| (5 wt %, T_{NI} = 70° C.) | | |
| COMPARATIVE EXAMPLE 4 | 99.5 | 94.3 |
| (5 wt %, T_{NI} = 80° C.) | | |
| EXAMPLE 3 | 99.5 | 99.1 |
| (5 wt %, T_{NI} = 90° C.) | | |

As shown in Table 3, even when the liquid crystal material contained 5 wt % of the second liquid crystal compound, the VHR was reduced after the high-temperature and high-humidity test when the T_{NI} of the liquid crystal material was low (i.e., when the T_{NI} was 70° C. or 80° C.). This is because when the T_{NI} of the liquid crystal material is close to the temperature (60° C.) of the high-temperature and high-humidity test, the viscosity of the liquid crystal material (liquid crystal layer) reduces and the fluidity of the liquid crystal layer increases, and therefore once moisture penetrates through the sealant into the liquid crystal layer, the moisture quickly diffuses in the liquid crystal layer even when the amount of the moisture is extremely small, so that part of the polyamic acid-based photo-alignment film easily dissolves into the liquid crystal layer. The part of the photo-alignment film that has dissolved into the liquid crystal layer also more quickly diffuses in the liquid crystal layer in a high-temperature and high-humidity test environment (temperature: 60° C., humidity: 95%) when the T_{NI} of the liquid crystal material is lower. When the part of the photo-alignment film that has dissolved into the liquid crystal layer diffuses in the liquid crystal layer, radicals generated from the part of the photo-alignment film by irradiation with light emitted from the backlight are easily transferred to the first liquid crystal compound (containing an alkenyl group) contained in the liquid crystal material. As described above, it was confirmed that when the T_{NI} of the liquid crystal material is low, the VHR tends to reduce.

On the other hand, it was confirmed that the VHR of the liquid crystal cell of Example 3 whose liquid crystal material had a T_{NI} of 90° C. hardly reduced after the high-temperature and high-humidity test. It is assumed that the reason for this is that the amount of moisture penetrating into the liquid crystal layer was originally extremely small and the moisture hardly diffused in the liquid crystal layer, and therefore the amount of the polyamic acid-based alignment film that dissolved into the liquid crystal layer was kept extremely small.

### Example 7: UV2A (4D-RTN) Mode

(Production of Liquid Crystal Cell)

An array substrate for UV2A mode having a glass substrate and TFTs, pixel electrodes, and the like formed on the glass substrate and a counter substrate for UV2A mode (with electrode) having a glass substrate and color filters and the like formed on the glass substrate were prepared. An aligning agent for vertical alignment containing polyamic acid represented by the following chemical formulas (5), (9-6), (10-2), and (8-3) was applied onto the substrate surface of each of the array substrate and the counter substrate by spin coating, and the coated material was preliminarily fired by heating at 80° C. for 2 minutes and then finally fired by heating at 200° C. for 40 minutes. Then, the coated material was subjected to photo-alignment treatment by irradiation with linear polarized light (including ultraviolet light with a wavelength of 310 nm to 370 nm) at 20 mJ/cm² from a predetermined direction. In this way, a photo-alignment film was formed on the substrate surface of each of the array substrate and the counter substrate.

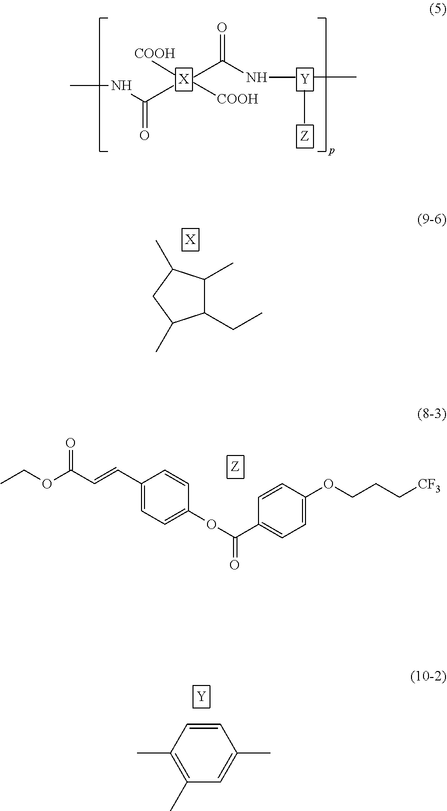

Then, the same uncured sealant for ODF as used in Example 1 was applied onto the photo-alignment film of the array substrate so as to have a frame shape with the use of a dispenser.

Then, a liquid crystal material was dropped in a predetermined position on the photo-alignment film of the counter substrate. The liquid crystal material contains a first liquid crystal compound having an unsaturated bond and a second liquid crystal compound having a negative dielectric constant anisotropy and represented by the following chemical formula (17). The second liquid crystal compound content of the liquid crystal material is 1 wt %.

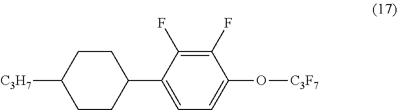

The first liquid crystal compound was appropriately selected from alkenyl group-containing liquid crystal compounds represented by the chemical formulas (3-1) to (3-4) in the description of the present application such that the entire liquid crystal compound had a T_{NI} of 90° C.

Then, the array substrate and the counter substrate were bonded together under vacuum to form a laminate, and the sealant of the laminate was optically cured by irradiation with ultraviolet light (including ultraviolet light of 300 nm to 400 nm). Further, the laminate was heated at 130° C. for 40 minutes to thermally cure the sealant to seal the liquid crystal material and to perform re-alignment treatment to allow the liquid crystal material to be in its isotropic phase. Then, the laminate was cooled to room temperature to obtain a UV2A mode liquid crystal cell. It is to be noted that the line width of the thinnest portion of the sealant was 1.0 mm or less.

### Example 8: UV2A (4D-RTN) Mode

A liquid crystal cell of Example 8 was produced in the same manner as in Example 7 except that the second liquid crystal compound content of the liquid crystal material was changed to 3 wt %.

### Example 9: UV2A (4D-RTN) Mode

A liquid crystal cell of Example 9 was produced in the same manner as in Example 7 except that the second liquid crystal compound content of the liquid crystal material was changed to 5 wt %.

### Comparative Example 4: UV2A (4D-RTN) Mode

A liquid crystal cell of Comparative Example 4 was produced in the same manner as in Example 7 except that the second liquid crystal compound was not added to the liquid crystal material.

(High-temperature and high-humidity test)

A high-temperature and high-humidity test was performed on each of the liquid crystal cells of Examples 7 to 9 and Comparative Example 4 in the same manner as in Example 1. The voltage holding ratio (VHR) of each of the liquid crystal cells was measured before and after the liquid crystal cell was allowed to stand for 1000 hours (i.e., at the start of the test and after 1000 hours from the start of the test). The results are shown in Table 4.

TABLE 4

| | VHR (%) AT | VHR (%) AFTER |
|---|---|---|
| | START OF TEST | 1000 HOURS |
| COMPARATIVE | 99.3 | 84.3 |
| EXAMPLE 4 (0 wt %) | | |
| EXAMPLE 7 (1 wt %) | 99.2 | 88.5 |
| EXAMPLE 8 (3 wt %) | 99.2 | 97.0 |
| EXAMPLE 9 (5 wt %) | 99.3 | 98.5 |

As shown in Table 4, the VHR of the liquid crystal cell of Comparative Example 4 whose liquid crystal material contained no second liquid crystal compound was reduced to the order of 80% after a lapse of 1000 hours from the start of the test. On the other hand, similarly to Example 1, the VHR of each of the liquid crystal cells of Examples 7 and 8 whose liquid crystal layer contained the second liquid crystal compound was prevented from being significantly reduced after the high-temperature and high-humidity test (after 1000 hours). Particularly, the VHR of each of the liquid crystal cells of Examples 8 and 9 was maintained at 97% or higher after the high-temperature and high-humidity test (after 1000 hours). As described above, it was confirmed that similarly to the horizontal alignment mode of Example 1 and the like, even when the liquid crystal alignment mode of the liquid crystal cell is a vertical alignment mode such as a UV2A (4D-RTN) mode and the photo-alignment film has a cinnamate group as a photo-functional group, a reduction in VHR can be prevented by adding the second liquid crystal compound having a fluorine group to the liquid crystal material.

It is to be noted that the VHR of each of the vertical alignment mode liquid crystal cells of Examples 7 to 9 is slightly lower than that of the horizontal alignment mode liquid crystal cell of Example 1 and the like. This results from the fact that the liquid crystal material used in the vertical alignment mode has a negative dielectric constant anisotropy.

### EXPLANATION OF SYMBOLS

10: Liquid crystal display
11: Liquid crystal panel
12: Backlight
13: Casing
14: Liquid crystal cell
15, 16: Polarizer
17: Substrate (Array substrate)
17a: Photo-alignment film
18: Substrate (Counter substrate)
18a: Photo-alignment film
19: Liquid crystal layer
20: Sealant

1. A liquid crystal cell comprising:
a pair of substrates facing each other and including opposing surfaces on at least one of which a photo-alignment film is provided;
a liquid crystal layer interposed between the substrates; and
a sealant interposed between the substrates so as to surround the liquid crystal layer,
wherein
the photo-alignment film contains a polymer having a polyamic acid as a main chain and a photo-functional group, and
the liquid crystal layer contains:
a first liquid crystal compound having an unsaturated bond; and
a second liquid crystal compound containing at least one compound selected from the group consisting of:
a compound represented by a formula (I): A¹-CₙF₂ₙB-A²; and
a compound represented by a formula (II): A¹-BCₙF₂ₙ₊₁,
where n is an integer of 1 to 6, A¹ and A² are each independently at least one substituent group selected from the group consisting of a phenyl group, a phenylene group, a naphthyl group, a naphthylene group, a cyclohexyl group, and a cyclohexylene group, at least one hydrogen atom contained in the substituent group may be substituted with an F atom, a Cl atom, a Br atom, a methyl group, or an ethyl group, and B is an O atom or a direct bond.

2. The liquid crystal cell according to claim 1, wherein the second liquid crystal compound contains at least one structure selected from the group consisting of structures represented by the following chemical formulas (1-1) to (1-4): 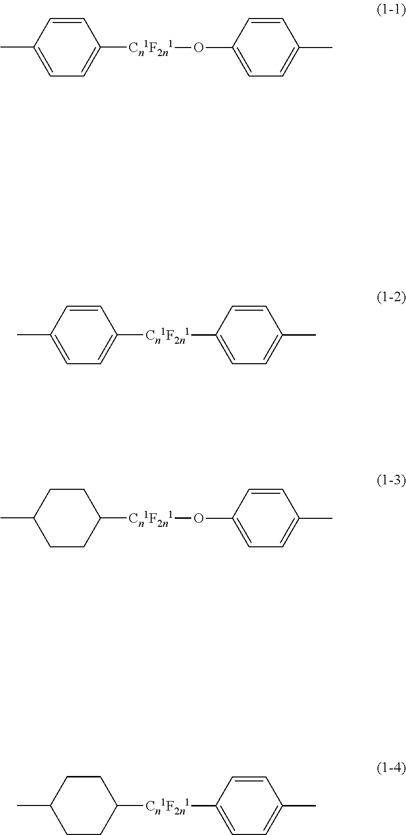
where n¹ is an integer of 1 to 6, and at least one hydrogen atom contained in an aromatic ring or an aliphatic ring in each of the chemical formulas (1-1) to (1-4) may be substituted with an F atom, a Cl atom, a Br atom, a methyl group, or an ethyl group.

3. The liquid crystal cell according to claim 1, wherein the second liquid crystal compound contains at least one structure selected from the group consisting of structures represented by the following chemical formulas (2-1) and (2-2): 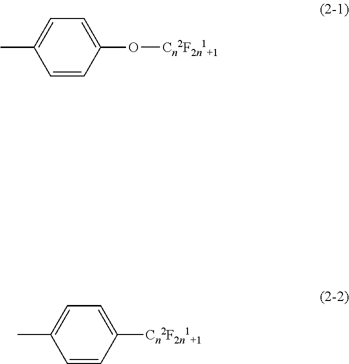
where n² is an integer of 1 to 6, and at least one hydrogen atom contained in an aromatic ring in each of the chemical formulas (2-1) and (2-2) may be substituted with an F atom, a Cl atom, a Br atom, a methyl group, or an ethyl group.

4. The liquid crystal cell according to claim 1, wherein the first liquid crystal compound is at least one selected from the group consisting of alkenyl group-containing compounds represented by the following chemical formulas (3-1) to (3-4): 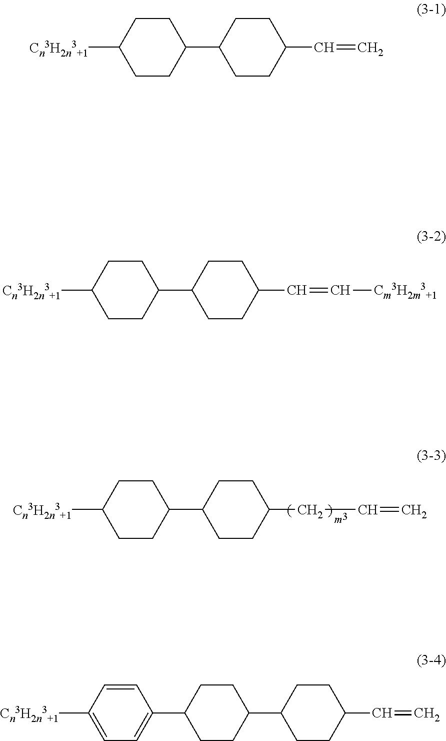
where n³ and m³ are the same or different integers of 1 to 6.

5. The liquid crystal cell according to claim 1, wherein the liquid crystal layer has a liquid crystal phase-isotropic phase transition temperature (T_{NI}) of 90° C. or higher.

6. The liquid crystal cell according to claim 1, wherein the sealant contains a compound represented by the following chemical formula (4): 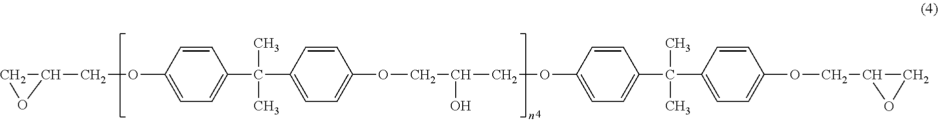
where n⁴ is an integer of 0 to 3.

7. The liquid crystal cell according to claim 1, wherein the sealant has a portion having a line width of 1.0 mm or less.

8. The liquid crystal cell according to claim 1, wherein the sealant contains a polymer of an acrylic monomer and a photo-radical polymerization initiator used for polymerization of the acrylic monomer.

9. The liquid crystal cell according to claim 1, wherein
the photo-alignment film is a horizontal alignment film, and
the first liquid crystal compound and the second liquid crystal compound in the liquid crystal layer are aligned substantially parallel to the photo-alignment film.

10. The liquid crystal cell according to claim 1, wherein
the photo-alignment film is a vertical alignment film, and
the first liquid crystal compound and the second liquid crystal compound in the liquid crystal layer are aligned substantially vertically to the photo-alignment film.

11. The liquid crystal cell according to claim 1, whose liquid crystal alignment mode is any one of a TN mode, an ECB mode, an IPC mode, an FFS mode, a VA mode, a VATN mode, and a UV2A mode.

12. A liquid crystal display comprising:
a liquid crystal panel comprising the liquid crystal cell according to claim 1; and
a backlight that supplies light to the liquid crystal panel.
